(19) United States
(12) Patent Application Publication
(10) Pub. No.: US 2010/0134019 A1
(43) Pub. Date: Jun. 3, 2010

(54) METHOD FOR OPERATING A LIGHTING SYSTEM AND LIGHTING DEVICE FOR CARRYING OUT THIS METHOD

(75) Inventor: Rene Berhorst, Hovelhof (DE)

Correspondence Address: SCHWEGMAN, LUNDBERG & WOESSNER, P.A., P.O. BOX 2938, MINNEAPOLIS, MN, 55402, US

(73) Assignee: MA LIGHTING TECHNOLOGY GmbH, Waldbuttelbrunn (DE)

(21) Appl. No.: 12/326,564

(22) Filed: Dec. 2, 2008

(51) Int. Cl. H05B 37/02

(52) U.S. Cl. 315/130

(57) ABSTRACT

The invention relates to a method for operating a lighting system having at least one central control device and a plurality of lighting devices, wherein at least one point of light can be created with each lighting device, and wherein at least one illumination parameter can be modified with a local control device in each lighting device, and wherein the location of the lighting device can be determined with a positioning sensor system in each lighting device, and wherein data transmitted wirelessly can be received from the central control device by each lighting device via a data interface, with the following process steps:
a) generation of an illuminated pattern in the central control device, wherein the illuminated pattern contains a plurality of location indicators and illumination parameters assigned to the location indicators;
b) wireless transmission of the illuminated pattern from the central control device to various lighting devices;
c) determination of the location of the each individual lighting device by the positioning sensor system;
d) modification of the illumination parameter in each lighting device as a function of the current location thereof to display the illuminated pattern via the entirety of the lighting devices.

The invention relates to a method for operating a lighting system that includes at least one central control device, for example a lighting control console, and a plurality of lighting devices in accordance with the preamble of claim 1. The invention further relates to a lighting device for carrying out the method.

At large-scale events, for example soccer matches in large stadiums or music concerts in large auditoriums, it is known that individual spectators create certain light effects by switching on simple lighting devices, for example cigarette lighters or glow sticks. However, these light effects are limited to creating a certain total light output or a certain lighting color. On the other hand, specific illuminated patterns, for example for displaying captions, logos or similar, cannot be created because all of the lighting devices ultimately have the same illumination parameter, so that it is only possible to create an essentially uniform carpet of light.

Given the existing state of the art, it is therefore the object of the present invention to suggest a new method for operating a lighting system, which may be used to display large illuminated patterns without a preset arrangement of the various lighting devices involved. It is a further object of the invention to suggest a novel lighting device for carrying out the method of the invention.

These objects are attained with a method and a lighting device as recited in the teaching of the two independent claims.

Advantageous embodiments of the invention are described in the subordinate claims.

The lighting system for carrying out the method according to the invention includes a central control device and a plurality of lighting devices. Each individual lighting device, which may be for example a small lamp with a light emitting diode as the light source, may be used to create at least one point of light. Additionally, at least one illumination parameter may be modified in each lighting device by means of local control device. In its simplest form, this modification of the illumination parameter means that the lighting device is switched on or off. Each lighting device is also equipped with a positioning sensor system with which the current location of the lighting device may be determined. The positioning sensor system may be for example a GPS receiver. However, other positioning sensor systems are also conceivable, since reception of GPS signals is relatively poor in soccer stadiums, for example. Each of the lighting devices is also equipped with a wireless data interface, with which data transmitted wirelessly may be received from the central control device. The data interface may be for example a GSM, UMTS, WiFi or Bluetooth data interface.

The method according to the invention is carried out in the following process steps:

First, an illuminated pattern is generated in the central control device. This illuminated pattern represents the image that is to be displayed with the lighting system, for example an advertising logo or an advertising message in the form of a caption. In order to be able to represent the image to be displayed by the illuminated pattern, the illuminated pattern contains a number of location indicators, at least one illumination parameter being assigned to each location indicator. As a result, the illuminated pattern thus defines a location pattern in which one specific illumination parameter is assigned to each of the various zones or locations in the location pattern. By varying the different illumination parameters as a function of their respective positions in the location pattern, it is thus possible to display the required image.

The central control device then wirelessly transmits the illuminated pattern to the data interfaces of the various lighting devices involved in the display of the illuminated pattern.

In the lighting devices as such the location of each individual lighting device is also established by the positioning sensor system provided in the lighting devices. Then, the local control device in the lighting device uses the individually determined location and the illuminated pattern that was transmitted wirelessly to calculate which illumination parameter is to be currently displayed by the respective lighting device. Depending on this calculation, the illumination parameter is then altered individually depending on the current location, so that the required image is displayed by all of the lighting devices involved.

The lighting system according to the invention has the decisive advantage that the individual locations of the various lighting devices participating in the display of the illuminated pattern no longer need to be known beforehand. Instead, the current location of each lighting device may be determined with the aid of the positioning sensor system provided in each lighting device, and the location indicator that is closest to the current location in each case may be filtered out from the wirelessly transmitted illuminated pattern that contains all location indicators and the illumination parameters assigned to each of them. If the current location of any individual lighting device changes, for example because a spectator leaves his seat or moves to another spot, the illumination parameters are changed correspondingly for all lighting devices whose location has been changed, so that as a result it is possible to continue displaying the desired illuminated pattern. It is also possible to display moving images with the entirety of the participating lighting devices by altering the timing of the wirelessly transmitted illuminated pattern.

The actual configuration of the illuminated pattern and the data to be transmitted wirelessly is essentially infinitely variable. It is particularly advantageous if the illuminated pattern is made up of a number of points of light. Each point of light is defined by a location indicator within a given location range, and an illumination parameter is assigned to each of these points of light.

As was explained earlier, an example of an illumination parameter transmitted may be the switching condition of the lighting device, which in turn means that the lighting device may be switched on or off individually as a function of its current location. The illumination intensity of the lighting device and/or the light color of the lighting device may be transmitted as alternative or additional illumination parameters.

The respective location indicator in the illuminated pattern may be transmitted as two-dimensional or three-dimensional space coordinates relative to a predefined reference point.

In order for the positioning sensor system of the lighting device to be able to determine the location, the differences between signal propagation delays may be evaluated, particularly the differences between GPS signals or differential GPS signals. Alternatively, tracking transmitters may also be set up so that the lighting devices are able to take a bearing on their own positions.

The method according to the invention is of particular significance when it is implemented in a sports stadium or concert hall. In this context, each spectator in the sports stadium or concert hall carries a lighting device and together they are able to display a predetermined illuminated pattern over a large area by applying the method of the invention.

The method according to the invention is particularly interesting for commercial purposes when advertising messages are displayed as an illuminated pattern.

The novel lighting device for carrying out the method according to the invention is equipped conventionally with at least one light source for creating a point of light. In addition, at least one illumination parameter of the lighting device may be modified via a local control device, which may be a switch, for example. The novel lighting device differs from the related art in that it has a wireless data interface and a positioning sensor system. Data transmitted wirelessly from a central control device may be received via the data interface. The positioning sensor system makes it possible to determine the location of the lighting device. Then, the respective illumination parameter to be set is determined in the local control device installed in the lighting device on the basis of the data of the illuminated pattern and the current location, and is set for the respective lighting device.

In order to simplify the use of the lighting device, particularly at large-scale events, it is particularly advantageous to be able to attach the lighting device to an item of clothing permanently or detachably. It has proven particularly advantageous to attach the lighting device to an item of headgear, for example a cap, since when spectators wear such items on the head, the light image produced thereby is reproduced very effectively when viewed from above.

It is also particularly advantageous if the data interface in the lighting device enables a bi-directional data exchange with the central control device, and data describing the current location can be sent from each lighting device to the central control device. Consequently, this makes it possible for each lighting device's current location at any given time to be transmitted to the central control device, which may then calculate the illumination parameter for each lighting device as a function of its current location. The corresponding illumination parameter may then be transmitted by the central control device separately to the various lighting devices depending on their respective locations. This exchange of data between the central control device and the various lighting devices may be enabled for example by multiplex mode on several frequency bands, or by unicast data transmission.

1. A method for operating a lighting system comprising:
having at least one central control device and a plurality of lighting devices, wherein at least one point of light can be created with each lighting device, and wherein at least one illumination parameter can be modified with a local control device in each lighting device, and wherein the location of the lighting device can be determined with a positioning sensor system in each lighting device, and wherein data transmitted wirelessly can be received from the central control device by each lighting device via a data interface, the method including:
a) generation of an illuminated pattern in the central control device, wherein the illuminated pattern contains a plurality of location indicators and illumination parameters assigned to the location indicators;
b) wireless transmission of the illuminated pattern from the central control device to various lighting devices;
c) determination of the location of the each individual lighting device by the positioning sensor system; and
d) modification of the illumination parameter in each lighting device as a function of the current location thereof to display the illuminated pattern via the entirety of the lighting devices.

2. The method according to claim 1, wherein the illumination pattern consists of a large number of points of light, to each of which a location indicator and at least one illumination parameter is assigned.

3. The method according to claim 1, wherein the switching status of the lighting device and the light intensity of the lighting device and the light color of the lighting device are transmitted as the illumination parameter.

4. The method according to claim 1, wherein a two-dimensional or a three-dimensional space coordinate relative to a predefined reference point is transmitted as the location indicator.

5. The method according to claim 1, wherein the location of the lighting device is determined by the positioning sensor system by evaluating the difference between signal propagation delays, in particular by evaluating the difference between GPS signals or differential GPS signals.

6. The method according to claim 1, wherein the method is carried out in a sports stadium.

7. The method according to claim 6, wherein each of the spectators in the sports stadium carries an individual lighting device.

8. The method according to claim 1, wherein the illuminated pattern is arranged in the manner of an advertising message.

9. A lighting device comprising:
the lighting device wherein at least one point of light can be created with the lighting device, and wherein at least one illumination parameter can be modified with a local control device in the lighting device,
a data interface and a positioning sensor system are provided in the lighting device, wherein data transmitted wirelessly from the central control device can be received via the data interface, and wherein the location of the lighting device can be determined via the positioning sensor system,
and wherein the illumination parameter of the lighting device can be modified by the local control device as a function of the current location of the lighting device.

10. The lighting device according to claim 9, wherein the lighting device can be attached permanently or detachably to an item of clothing.

11. The lighting device according to claim 10, wherein the lighting device is attached to an item of headgear.

12. The lighting device according to claim 9, wherein the data interface provides the lighting device with the capability of bidirectional data exchange with the central control device, and data describing the current location of each lighting device can be sent from the lighting device to the central control device.

13. The method according to claim 1, wherein at least one of the switching status of the lighting device or the light intensity of the lighting device or the light color of the lighting device is transmitted as the illumination parameter.
